(19) United States
(12) Patent Application Publication
(10) Pub. No.: US 2023/0146162 A1
(43) Pub. Date: May 11, 2023

(54) COMMUNICATION METHOD USING NETWORK SLICE

(71) Applicant: LG Electronics Inc., Seoul (KR)

(72) Inventors: Sungduck CHUN, Seoul (KR); Hyunsook KIM, Seoul (KR)

(21) Appl. No.: 17/912,757

(22) PCT Filed: Mar. 19, 2021
(86) PCT No.: PCT/KR2021/003406

§ 371 Date: Sep. 19, 2022

(30) Foreign Application Priority Data
Mar. 20, 2020 (KR) 10-2020-0034406
Mar. 20, 2020 (KR) 10-2020-0034408
Mar. 24, 2020 (KR) 10-2020-0035865

(51) Int. Cl. H04W 60/00; H04W 48/20; H04W 36/08

(52) U.S. Cl. CPC H04W 60/00; H04W 48/20; H04W 36/08

(57) ABSTRACT

One disclosure of the present specification provides a method by which a network allows user equipment (UE) to communicate. The method comprises the steps of: receiving, from the UE, a registration request message including a provision request for a specific network slice; determining whether the network can provide a service for the specific network slice to the UE, on the basis of i) the registration request message, ii) the specific network slice, iii) subscription information and the like about the UE; and transmitting a response message to a base station on the basis of the network not being able to provide the service for the specific network slice to the UE, wherein the response message includes information about the rejection of the provision request for the specific network slice, and the response message can include network slice support information related to the specific network slice.

### BACKGROUND

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

In the network slice technology, when the UE makes a service request for a required network slice, but the corresponding network does not provide the service for the network slice, a method is required for the UE to efficiently receive the service for the network slice.

### SUMMARY

The AMF may be provided with terminal information and network slice support information from the UDM, and may provide the UE with information about the network slice required by the terminal.

The present specification may have various effects.

For example, through the procedure disclosed in the present specification, the UE can effectively connect to a network slice required for the UE and receive a service.

Effects that can be obtained through specific examples of the present specification are not limited to the effects listed above. For example, various technical effects that a person having ordinary skill in the related art can understand or derive from the present specification may exist. Accordingly, the specific effects of the present specification are not limited to those explicitly described herein, and may include various effects that can be understood or derived from the technical characteristics of the present specification.

### BRIEF DESCRIPTION OF THE DRAWINGS

FIG. 1 shows an example of a communication system to which implementations of the present disclosure is applied.

FIG. 2 shows an example of wireless devices to which implementations of the present disclosure is applied.

FIG. 3 shows an example of a wireless device to which implementations of the present disclosure is applied.

FIG. 4 shows an example of UE to which implementations of the present disclosure is applied.

FIGS. 5 and 6 show an example of a registration procedure to which implementations of the present disclosure is applied.

FIG. 7 is an exemplary diagram illustrating an example of an architecture for implementing the concept of network slicing.

FIG. 8 is an exemplary diagram illustrating another example of an architecture for implementing the concept of network slicing.

FIG. 9 is an exemplary diagram illustrating an architecture for implementing the concept of network slicing.

FIG. 10 shows a first disclosure of the present specification.

FIG. 11 shows a second disclosure of the present specification.

FIG. 12 shows a sixth disclosure of the present specification.

FIG. 13 shows the procedure of AMF in the sixth disclosure of the present specification.

FIG. 14 shows a procedure of the UE in the sixth disclosure of the present specification.

### DETAILED DESCRIPTION

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. Evolution of 3GPP LTE includes LTE-A (advanced), LTE-A Pro, and/or 5G NR (new radio).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure. “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure. “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”. “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

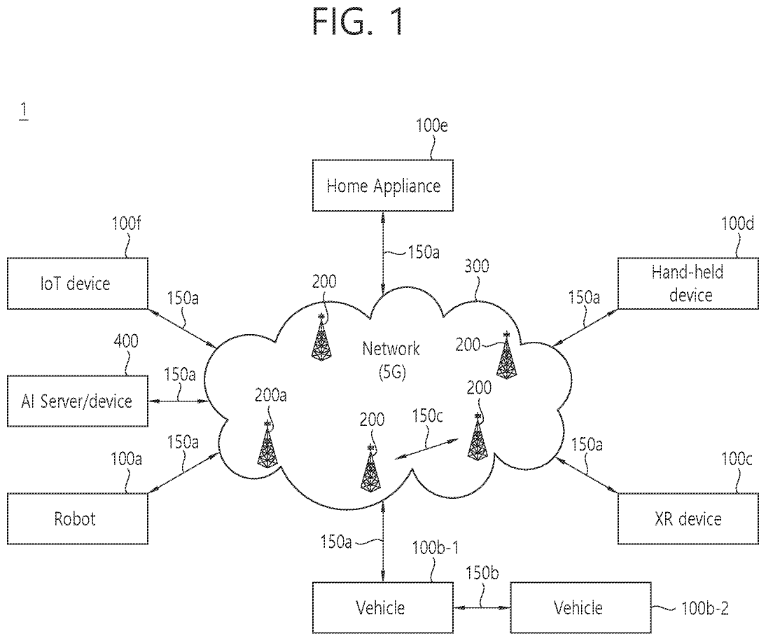

FIG. 1 Shows an Example of a Communication System to which Implementations of the Present Disclosure is Applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced mobile broadband (eMBB), (2) a category of massive machine type communication (mMTC), and (3) a category of ultra-reliable and low latency communications (URLLC).

Partial use cases may require a plurality of categories for optimization and other use cases may focus only upon one key performance indicator (KPI). 5G supports such various use cases using a flexible and reliable method.

eMBB far surpasses basic mobile Internet access and covers abundant bidirectional work and media and entertainment applications in cloud and augmented reality. Data is one of 5G core motive forces and, in a 5G era, a dedicated voice service may not be provided for the first time. In 5G, it is expected that voice will be simply processed as an application program using data connection provided by a communication system. Main causes for increased traffic volume are due to an increase in the size of content and an increase in the number of applications requiring high data transmission rate. A streaming service (of audio and video), conversational video, and mobile Internet access will be more widely used as more devices are connected to the Internet. These many application programs require connectivity of an always turned-on state in order to push real-time information and alarm for users. Cloud storage and applications are rapidly increasing in a mobile communication platform and may be applied to both work and entertainment. The cloud storage is a special use case which accelerates growth of uplink data transmission rate. 5G is also used for remote work of cloud. When a tactile interface is used, 5G demands much lower end-to-end latency to maintain user good experience. Entertainment, for example, cloud gaming and video streaming, is another core element which increases demand for mobile broadband capability. Entertainment is essential for a smartphone and a tablet in any place including high mobility environments such as a train, a vehicle, and an airplane. Other use cases are augmented reality for entertainment and information search. In this case, the augmented reality requires very low latency and instantaneous data volume.

In addition, one of the most expected 5G use cases relates a function capable of smoothly connecting embedded sensors in all fields, i.e., mMTC. It is expected that the number of potential Internet-of-things (IoT) devices will reach 204 hundred million up to the year of 2020. An industrial IoT is one of categories of performing a main role enabling a smart city, asset tracking, smart utility, agriculture, and security infrastructure through 5G.

URLLC includes a new service that will change industry through remote control of main infrastructure and an ultra-reliable/available low-latency link such as a self-driving vehicle. A level of reliability and latency is essential to control a smart grid, automatize industry, achieve robotics, and control and adjust a drone.

G is a means of providing streaming evaluated as a few hundred megabits per second to gigabits per second and may complement fiber-to-the-home (FTTH) and cable-based broadband (or DOCSIS). Such fast speed is needed to deliver TV in resolution of 4K or more (6K, 8K, and more), as well as virtual reality and augmented reality. Virtual reality (VR) and augmented reality (AR) applications include almost immersive sports games. A specific application program may require a special network configuration. For example, for VR games, gaming companies need to incorporate a core server into an edge network server of a network operator in order to minimize latency.

Automotive is expected to be a new important motivated force in 5G together with many use cases for mobile communication for vehicles. For example, entertainment for passengers requires high simultaneous capacity and mobile broadband with high mobility. This is because future users continue to expect connection of high quality regardless of their locations and speeds. Another use case of an automotive field is an AR dashboard. The AR dashboard causes a driver to identify an object in the dark in addition to an object seen from a front window and displays a distance from the object and a movement of the object by overlapping information talking to the driver. In the future, a wireless module enables communication between vehicles, information exchange between a vehicle and supporting infrastructure, and information exchange between a vehicle and other connected devices (e.g., devices accompanied by a pedestrian). A safety system guides alternative courses of a behavior so that a driver may drive more safely drive, thereby lowering the danger of an accident. The next stage will be a remotely controlled or self-driven vehicle. This requires very high reliability and very fast communication between different self-driven vehicles and between a vehicle and infrastructure. In the future, a self-driven vehicle will perform all driving activities and a driver will focus only upon abnormal traffic that the vehicle cannot identify. Technical requirements of a self-driven vehicle demand ultra-low latency and ultra-high reliability so that traffic safety is increased to a level that cannot be achieved by human being.

A smart city and a smart home/building mentioned as a smart society will be embedded in a high-density wireless sensor network. A distributed network of an intelligent sensor will identify conditions for costs and energy-efficient maintenance of a city or a home. Similar configurations may be performed for respective households. All of temperature sensors, window and heating controllers, burglar alarms, and home appliances are wirelessly connected. Many of these sensors are typically low in data transmission rate, power, and cost. However, real-time HD video may be demanded by a specific type of device to perform monitoring.

Consumption and distribution of energy including heat or gas is distributed at a higher level so that automated control of the distribution sensor network is demanded. The smart grid collects information and connects the sensors to each other using digital information and communication technology so as to act according to the collected information. Since this information may include behaviors of a supply company and a consumer, the smart grid may improve distribution of fuels such as electricity by a method having efficiency, reliability, economic feasibility, production sustainability, and automation. The smart grid may also be regarded as another sensor network having low latency.

Mission critical application (e.g., e-health) is one of 5G use scenarios. A health part contains many application programs capable of enjoying benefit of mobile communication. A communication system may support remote treatment that provides clinical treatment in a faraway place. Remote treatment may aid in reducing a barrier against distance and improve access to medical services that cannot be continuously available in a faraway rural area. Remote treatment is also used to perform important treatment and save lives in an emergency situation. The wireless sensor network based on mobile communication may provide remote monitoring and sensors for parameters such as heart rate and blood pressure.

Wireless and mobile communication gradually becomes important in the field of an industrial application. Wiring is high in installation and maintenance cost. Therefore, a possibility of replacing a cable with reconstructible wireless links is an attractive opportunity in many industrial fields. However, in order to achieve this replacement, it is necessary for wireless connection to be established with latency, reliability, and capacity similar to those of the cable and management of wireless connection needs to be simplified. Low latency and a very low error probability are new requirements when connection to 5G is needed.

Logistics and freight tracking are important use cases for mobile communication that enables inventory and package tracking anywhere using a location-based information system. The use cases of logistics and freight typically demand low data rate but require location information with a wide range and reliability.

Referring to FIG. 1, the communication system 1 includes wireless devices 100a to 100f, base stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using radio access technology (RAT) (e.g., 5G new RAT (NR)) or LTE) and may be referred to as communication/radio/5G devices. The wireless devices 100a to 100f may include, without being limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of performing communication between vehicles. The vehicles may include an unmanned aerial vehicle (UAV) (e.g., a drone). The XR device may include an AR/VR/Mixed Reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called user equipments (UEs). A UE may include, for example, a cellular phone, a smartphone, a laptop computer, a digital broadcast terminal, a personal digital assistant (PDA), a portable multimedia player (PMP), a navigation system, a slate personal computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a closed-circuit TV (CCTV), a recorder, or a black box.

The FinTech device may be, for example, a device capable of providing a financial service such as mobile payment. For example, the FinTech device may include a payment device or a point of sales (POS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., vehicle-to-vehicle (V2V)/vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or device-to-device (D2D) communication) 150b, inter-base station communication 150c (e.g., relay, integrated access and backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

AI refers to the field of studying artificial intelligence or the methodology that can create it, and machine learning refers to the field of defining various problems addressed in the field of AI and the field of methodology to solve them. Machine learning is also defined as an algorithm that increases the performance of a task through steady experience on a task.

Robot means a machine that automatically processes or operates a given task by its own ability. In particular, robots with the ability to recognize the environment and make self-determination to perform actions can be called intelligent robots. Robots can be classified as industrial, medical, home, military, etc., depending on the purpose or area of use. The robot can perform a variety of physical operations, such as moving the robot joints with actuators or motors. The movable robot also includes wheels, brakes, propellers, etc., on the drive, allowing it to drive on the ground or fly in the air.

Autonomous driving means a technology that drives on its own, and autonomous vehicles mean vehicles that drive without user's control or with minimal user's control. For example, autonomous driving may include maintaining lanes in motion, automatically adjusting speed such as adaptive cruise control, automatic driving along a set route, and automatically setting a route when a destination is set. The vehicle covers vehicles equipped with internal combustion engines, hybrid vehicles equipped with internal combustion engines and electric motors, and electric vehicles equipped with electric motors, and may include trains, motorcycles, etc., as well as cars. Autonomous vehicles can be seen as robots with autonomous driving functions.

Extended reality is collectively referred to as VR, AR, and MR. VR technology provides objects and backgrounds of real world only through computer graphic (CG) images. AR technology provides a virtual CG image on top of a real object image. MR technology is a CG technology that combines and combines virtual objects into the real world. MR technology is similar to AR technology in that they show real and virtual objects together. However, there is a difference in that in AR technology, virtual objects are used as complementary forms to real objects, while in MR technology, virtual objects and real objects are used as equal personalities.

NR supports multiples numerologies (and/or multiple subcarrier spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., FR1 and FR2. The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter wave (mmW).

TABLE 1

| Frequency Range | Corresponding | Subcarrier |
|---|---|---|
| designation | frequency range | Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency Range | Corresponding | Subcarrier |
|---|---|---|
| designation | frequency range | Spacing |
| FR1 | 410 MHz-7125 MHz | 15, 30, 60 kHz |
| FR2 | 24250 MHz-52600 MHz | 60, 120, 240 kHz |

Here, the radio communication technologies implemented in the wireless devices in the present disclosure may include narrowband internet-of-things (NB-IoT) technology for low-power communication as well as LTE, NR and 6G. For example, NB-IoT technology may be an example of low power wide area network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced machine type communication (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate personal area networks (PANs) associated with small/low-power digital communication based on various specifications such as IEEE 802.15.4 and may be called various names.

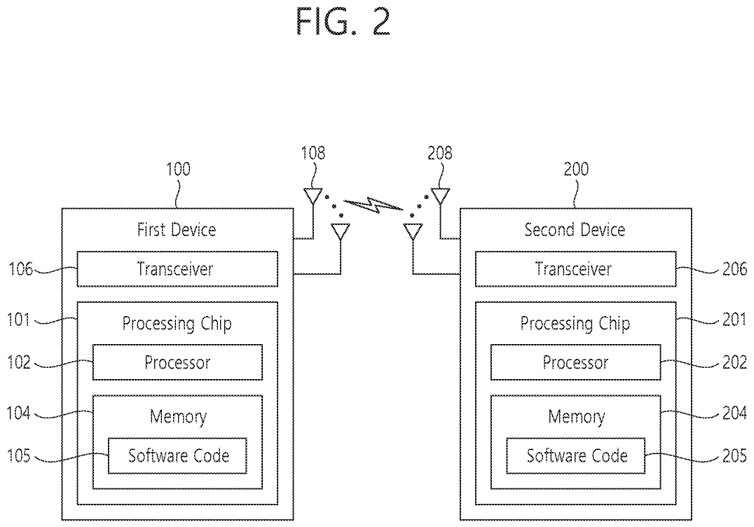

FIG. 2 Shows an Example of Wireless Devices to which Implementations of the Present Disclosure is Applied.

Referring to FIG. 2, a first wireless device 100 and a second wireless device 200 may transmit/receive radio signals to/from an external device through a variety of RATs (e.g., LTE and NR).

In FIG. 2, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. It is exemplarily shown in FIG. 2 that the memory 104 is included in the processing chip 101. Additional and/or alternatively, the memory 104 may be placed outside of the processing chip 101.

The processor 102 may control the memory 104 and/or the transceiver 106 and may be configured to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a software code 105 which implements instructions that, when executed by the processor 102, perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols. For example, the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with radio frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. It is exemplarily shown in FIG. 2 that the memory 204 is included in the processing chip 201. Additional and/or alternatively, the memory 204 may be placed outside of the processing chip 201.

The processor 202 may control the memory 204 and/or the transceiver 206 and may be configured to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, media access control (MAC) layer, radio link control (RLC) layer, packet data convergence protocol (PDCP) layer, radio resource control (RRC) layer, and service data adaptation protocol (SDAP) layer). The one or more processors 102 and 202 may generate one or more protocol data units (PDUs) and/or one or more service data unit (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs. SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, suggestions, methods and/or operational flowcharts disclosed in the present disclosure may be implemented using firmware or software and the firmware or software may be configured to include the modules, procedures, or functions. Firmware or software configured to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

In the implementations of the present disclosure, a UE may operate as a transmitting device in uplink (UL) and as a receiving device in downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be configured to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be configured to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

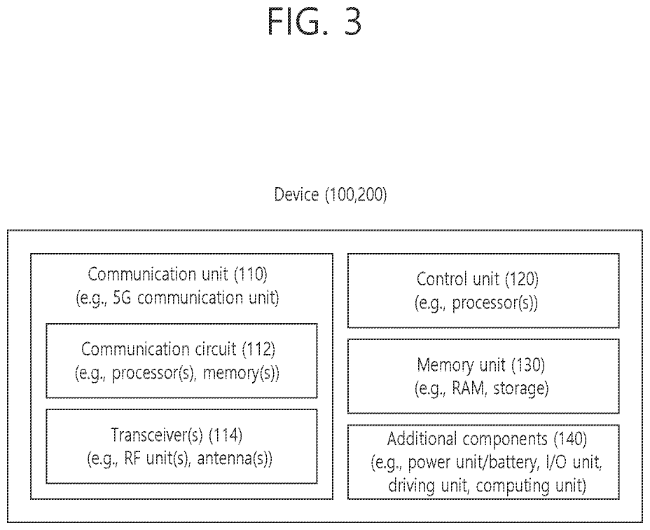

FIG. 3 Shows an Example of a Wireless Device to which Implementations of the Present Disclosure is Applied.

The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory unit 130, and the additional components 140 and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, input/output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor (AP), an electronic control unit (ECU), a graphical processing unit, and a memory control processor. As another example, the memory unit 130 may be configured by a RAM, a DRAM, a ROM, a flash memory, a volatile memory, a non-volatile memory, and/or a combination thereof.

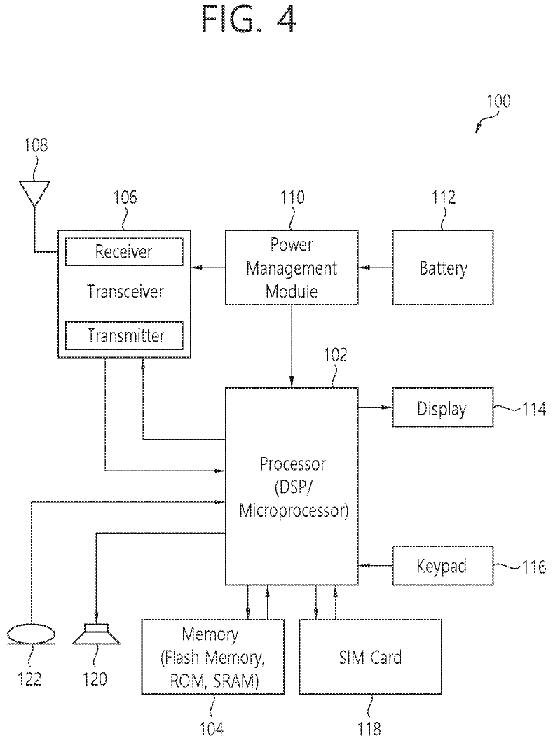

FIG. 4 Shows an Example of UE to which Implementations of the Present Disclosure is Applied.

Referring to FIG. 4, a UE 100 may correspond to the first wireless device 100 of FIG. 2 and/or the wireless device 100 or 200 of FIG. 3.

A UE 100 includes a processor 102, a memory 104, a transceiver 106, one or more antennas 108, a power management module 110, a battery 112, a display 114, a keypad 116, a subscriber identification module (SIM) card 118, a speaker 120, and a microphone 122.

The processor 102 may be configured to implement the descriptions, functions, procedures, suggestions, methods and/or operational flowcharts disclosed in the present disclosure. The processor 102 may be configured to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of a digital signal processor (DSP), a central processing unit (CPU), a graphics processing unit (GPU), a modem (modulator and demodulator). An example of the processor 102 may be found in SNAPDRAGON™ series of processors made by Qualcomm®, EXYNOS™ series of processors made by Samsung®, a series of processors made by Applet, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 110 manages power for the processor 102 and/or the transceiver 106. The battery 112 supplies power to the power management module 110.

The display 114 outputs results processed by the processor 102. The keypad 116 receives inputs to be used by the processor 102. The keypad 116 may be shown on the display 114.

The SIM card 118 is an integrated circuit that is intended to securely store the international mobile subscriber identity (IMSI) number and its related key, which are used to identify and authenticate subscribers on mobile telephony devices (such as mobile phones and computers). It is also possible to store contact information on many SIM cards.

The speaker 120 outputs sound-related results processed by the processor 102. The microphone 122 receives sound-related inputs to be used by the processor 102.

<Registration Procedure>

The registration procedure will be described.

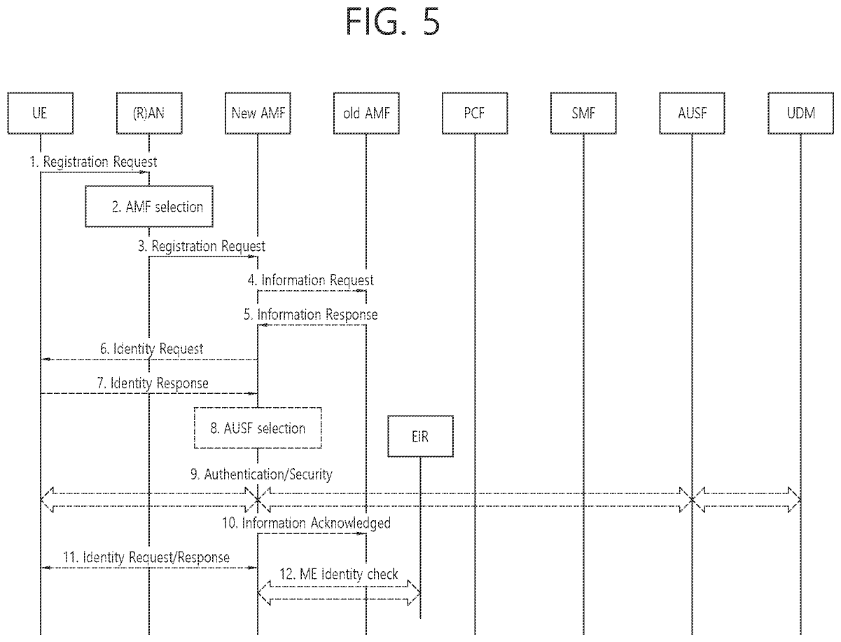

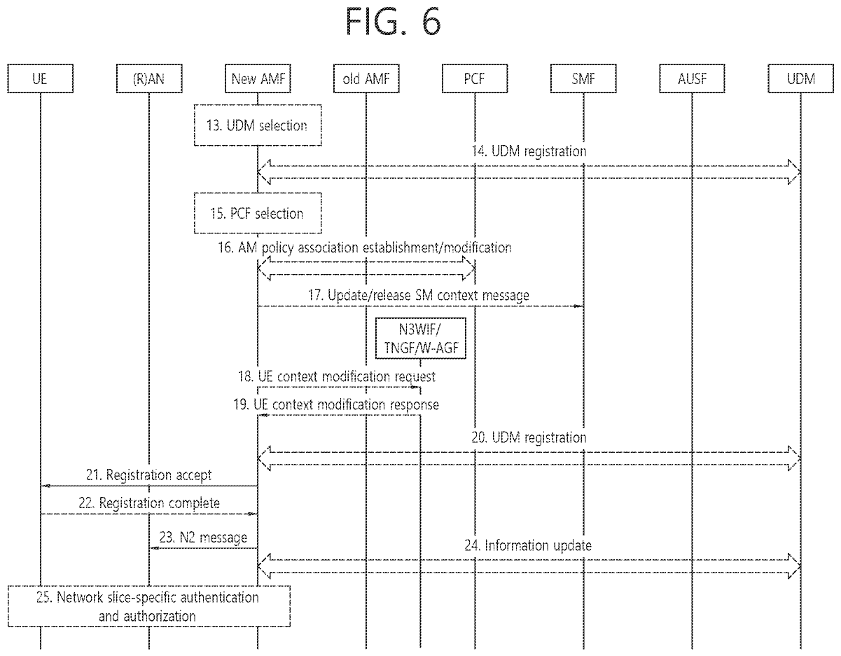

FIGS. 5 and 6 Show an Example of a Registration Procedure to which Implementations of the Present Disclosure is Applied.

A UE needs to register with the network to get authorized to receive services, to enable mobility tracking and to enable reachability. The UE initiates the registration procedure using one of the following registration types:
Initial registration to the 5GS; or
Mobility registration update; or
Periodic registration update; or
Emergency registration.

The general registration procedure in FIGS. 5 and 6 applies on all these registration procedures, but the periodic registration update need not include all parameters that are used in other registration cases.

The general registration procedure in FIGS. 5 and 6 is also used for the case of registration in 3GPP access when the UE is already registered in a non-3GPP access, and vice versa. Registration in 3GPP access when the UE is already registered in a non-3GPP access scenario may require an AMF change.

First, procedures of FIG. 5 are described.

(1) Step 1: The UE transmits a Registration Request message to the (R)AN. The Registration Request message corresponds to AN message.

The Registration Request message may include AN parameters. In the case of NG-RAN, the AN parameters include, e.g., 5G SAE temporary mobile subscriber identity (5G-S-TMSI) or globally unique AMF ID (GUAMI), the selected public land mobile network (PLMN) ID (or PLMN ID and network identifier (NID)) and Requested network slice selection assistance information (NSSAI). The AN parameters also include establishment cause. The establishment cause provides the reason for requesting the establishment of an RRC connection. Whether and how the UE includes the Requested NSSAI as part of the AN parameters is dependent on the value of the access stratum connection establishment NSSAI inclusion mode parameter.

The Registration Request message may include a registration type. The registration type indicates if the UE wants to perform an initial registration (i.e., the UE is in RM-DEREGISTERED state), a mobility registration update (i.e., the UE is in RM-REGISTERED state and initiates a registration procedure due to mobility or due to the UE needs to update its capabilities or protocol parameters, or to request a change of the set of network slices it is allowed to use), a periodic registration update (i.e., the UE is in RM-REGISTERED state and initiates a registration procedure due to the periodic registration update timer expiry) or an emergency registration (i.e., the UE is in limited service state).

When the UE is performing an initial registration, the UE shall indicate its UE identity in the Registration Request message as follows, listed in decreasing order of preference:

i) a 5G globally unique temporary identifier (5G-GUTI) mapped from an evolved packet system (EPS) GUT1, if the UE has a valid EPS GUTI.

ii) a native 5G-GUTI assigned by the PLMN to which the UE is attempting to register, if available;

iii) a native 5G-GUTI assigned by an equivalent PLMN to the PLMN to which the UE is attempting to register, if available;

iv) a native 5G-GUTI assigned by any other PLMN, if available.

v) Otherwise, the UE shall include its subscriber concealed identifier (SUCI) in the Registration Request message.

When the UE performing an initial registration has both a valid EPS GUTI and a native 5G-GUTI, the UE shall also indicate the native 5G-GUTI as additional GUTI. If more than one native 5G-GUTIs are available, the UE shall select the 5G-GUTI in decreasing order of preference among items (ii)-(iv) in the list above.

When the UE is performing an initial registration with a native 5G-GUTI, then the UE shall indicate the related GUAMI information in the AN parameters. When the UE is performing an initial registration with its SUCI, the UE shall not indicate any GUAMI information in the AN parameters.

For an emergency registration, the SUCI shall be included if the UE does not have a valid 5G-GUTI available; the permanent equipment identifier (PEI) shall be included when the UE has no subscriber permanent identifier (SUPI) and no valid 5G-GUTI. In other cases, the 5G-GUTI is included and it indicates the last serving AMF.

The Registration Request message may also include security parameters, PDU Session Status, etc. The security parameters are used for authentication and integrity protection. The PDU Session Status indicates the previously established PDU sessions in the UE. When the UE is connected to the two AMFs belonging to different PLMN via 3GPP access and non-3GPP access then the PDU Session status indicates the established PDU Session of the current PLMN in the UE.

(2) Step 2: The (R)AN selects an AMF.

If a 5G-S-TMSI or GUAMI is not included or the 5G-S-TMSI or GUAMI does not indicate a valid AMF, the (R)AN, based on (R)AT and requested NSSAI, if available, selects an AMF.

If UE is in CM-CONNECTED state, the (R)AN can forward the Registration Request message to the AMF based on the N2 connection of the UE.

If the (R)AN cannot select an appropriate AMF, it forwards the Registration Request message to an AMF which has been configured, in the (R)AN, to perform AMF selection.

(3) Step 3: The (R)AN transmits a Registration Request message to the new AMF. The Registration Request message corresponds to N2 message.

The Registration Request message may include whole information and/or a part of information included in the Registration Request message received from the UE which is described in step 1.

The Registration Request message may include N2 parameters. When NG-RAN is used, the N2 parameters include the selected PLMN ID (or PLMN ID and NID), location information and cell identity related to the cell in which the UE is camping, UE context request which indicates that a UE context including security information needs to be setup at the NG-RAN. When NG-RAN is used, the N2 parameters shall also include the establishment cause.

If the Registration type indicated by the UE is Periodic Registration Update, then steps 4 to 19 may be omitted.

(4) Step 4: If the UE's 5G-GUTI was included in the Registration Request message and the serving AMF has changed since last registration procedure, the new AMF may invoke the Namf_Communication_UEContextTransfer service operation on the old AMF including the complete registration request non-access stratum (NAS) message to request the UE's SUPI and UE context.

(5) Step 5: The Old AMF may respond to the new AMF for the Namf_Communication_UEContextTransfer invocation by including the UE's SUPI and UE context.

(6) Step 6: If the SUCI is not provided by the UE nor retrieved from the old AMF, the identity request procedure may be initiated by the new AMF sending the Identity Request message to the UE requesting the SUCI.

(7) Step 7: The UE may respond with an Identity Response message including the SUCI. The UE derives the SUCI by using the provisioned public key of the home PLMN (HPLMN).

(8) Step 8: The new AMF may decide to initiate UE authentication by invoking an AUSF. In that case, the new AMF selects an AUSF based on SUPI or SUCI.

(9) Step 9: Authentication/security may be established by the UE, new AMF, AUSF and/or UDM.

(10) Step 10: If the AMF has changed, the new AMF may notify the old AMF that the registration of the UE in the new AMF is completed by invoking the Namf_Communication_RegistrationCompleteNotify service operation. If the authentication/security procedure fails, then the registration shall be rejected, and the new AMF may invoke the Namf_Communication_RegistrationCompleteNotify service operation with a reject indication reason code towards the old AMF. The old AMF may continue as if the UE context transfer service operation was never received.

(11) Step 11: If the PEI was not provided by the UE nor retrieved from the old AMF, the Identity Request procedure may be initiated by the new AMF sending an Identity Request message to the UE to retrieve the PEI. The PEI shall be transferred encrypted unless the UE performs emergency registration and cannot be authenticated.

(12) Step 12: Optionally, the new AMF may initiate ME identity check by invoking the N5g-eir_EquipmentldentityCheck_Get service operation.

Now, procedures of FIG. 6, which follow the procedures of FIG. 5, are described.

(13) Step 13: if step 14 below is to be performed, the new AMF, based on the SUPI, may select a UDM, then UDM may select a UDR instance.

(14) Step 14: The new AMF may register with the UDM.

(15) Step 15: The new AMF may select a PCF.

(16) Step 16: The new AMF may optionally perform an AM Policy Association Establishment/Modification.

(17) Step 17: The new AMF may transmit Update/Release SM Context message (e.g., Nsmf_PDUSession_UpdateSMContext and/or Nsmf_PDUSession_ReleaseSMContext) to the SMF.

(18) Step 18: If the new AMF and the old AMF are in the same PLMN, the new AMF may send a UE Context Modification Request to the N31WF/TNGF/W-AGF.

(19) Step 19: The N3IWF/TNGF/W-AGF may send a UE Context Modification Response to the new AMF.

(20) Step 20: After the new AMF receives the response message from the N31WF/TNGF/W-AGF in step 19, the new AMF may register with the UDM.

(21) Step 21: The new AMF transmits a Registration Accept message to the UE.

The new AMF sends a Registration Accept message to the UE indicating that the Registration Request has been accepted. 5G-GUTI is included if the new AMF allocates a new 5G-GUTI. If the UE is already in RM-REGISTERED state via another access in the same PLMN, the UE shall use the 5G-GUTI received in the Registration Accept message for both registrations. If no 5G-GUTI is included in the Registration Accept message, then the UE uses the 5G-GUTI assigned for the existing registration also for the new registration. If the new AMF allocates a new registration area, it shall send the registration area to the UE via Registration Accept message. If there is no registration area included in the Registration Accept message, the UE shall consider the old registration area as valid. Mobility Restrictions is included in case mobility restrictions applies for the UE and registration type is not emergency registration. The new AMF indicates the established PDU sessions to the UE in the PDU Session status. The UE removes locally any internal resources related to PDU sessions that are not marked as established in the received PDU Session status. When the UE is connected to the two AMFs belonging to different PLMN via 3GPP access and non-3GPP access then the UE removes locally any internal resources related to the PDU session of the current PLMN that are not marked as established in received PDU Session status. If the PDU Session status information was in the Registration Request message, the new AMF shall indicate the PDU Session status to the UE.

The Allowed NSSAI provided in the Registration Accept message is valid in the registration area and it applies for all the PLMNs which have their tracking areas included in the registration area. The Mapping Of Allowed NSSAI is the mapping of each S-NSSAI of the Allowed NSSAI to the HPLMN S-NSSAIs. The Mapping Of Configured NSSAI is the mapping of each S-NSSAI of the Configured NSSAI for the serving PLMN to the HPLMN S-NSSAIs.

Furthermore, optionally the new AMF performs a UE Policy Association Establishment.

(22) Step 22: The UE may send a Registration Complete message to the new AMF when it has successfully updated itself.

The UE may send a Registration Complete message to the new AMF to acknowledge if a new 5G-GUTI was assigned.

(23) Step 23: For registration over 3GPP Access, if the new AMF does not release the signaling connection, the new AMF may send the RRC Inactive Assistance Information to the NG-RAN. For registration over non-3GPP Access, if the UE is also in CM-CONNECTED state on 3GPP access, the new AMF may send the RRC Inactive Assistance Information to the NG-RAN.

(24) Step 24: The new AMF may perform information update towards the UDM.

(25) Step 25: The UE may execute Network Slice-Specific Authentication and Authorization procedure.

<Cell Selection and Re-Selection>

In the mobile communication system, it is assumed that the UE continuously moves, and accordingly, in order to maintain the radio section between the UE and the base station in an optimal state, the UE may continuously perform a cell selection/reselection process.

For reselection, the UE may perform evaluation of cells. When evaluating Srxlev and Squal of non-serving cells for reselection evaluation purposes, the UE shall use parameters provided by the serving cell and for the final check on cell selection criterion, the UE shall use parameters provided by the target cell for cell reselection.

The NAS can control the RAT(s) in which the cell selection should be performed, for instance by indicating RAT(s) associated with the selected PLMN, and by maintaining a list of forbidden registration area(s) and a list of equivalent PLMNs. The UE shall select a suitable cell based on RRC_IDLE or RRC_INACTIVE state measurements and cell selection criteria.

In order to expedite the cell selection process, stored information for several RATs, if available, may be used by the UE.

When camped on a cell, the UE shall regularly search for a better cell according to the cell reselection criteria. If a better cell is found, that cell is selected. The change of cell may imply a change of RAT.

The NAS is informed if the cell selection and reselection result in changes in the received system information relevant for NAS.

Measurements for cell reselection have the following rules.
If the serving cell fulfils Srxlev>SIntraSearchP and Squal>SIntraSearchQ, the UE may choose not to perform intra-frequency measurements.
Otherwise, the UE shall perform intra-frequency measurements.
The UE shall apply the following rules for NR inter-frequencies and inter-RAT frequencies which are indicated in system information and for which the UE has priority
For a NR inter-frequency or inter-RAT frequency with a reselection priority higher than the reselection priority of the current NR frequency, the UE shall perform measurements of higher priority NR inter-frequency or inter-RAT frequencies
For a NR inter-frequency with an equal or lower reselection priority than the reselection priority of the current NR frequency and for inter-RAT frequency with lower reselection priority than the reselection priority of the current NR frequency:
If the serving cell fulfils Srxlev>SnonIntraSearchP and Squal>SnonIntraSearchQ, the UE may choose not to perform measurements of NR inter-frequencies or inter-RAT frequency cells of equal or lower priority;
Otherwise, the UE shall perform measurements of NR inter-frequencies or inter-RAT frequency cells of equal or lower priority

<Network Slice>

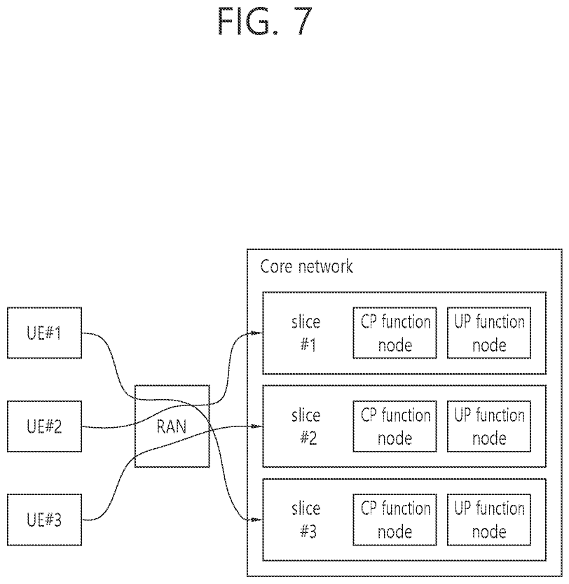

FIG. 7 is an Exemplary Diagram Illustrating an Example of an Architecture for Implementing the Concept of Network Slicing.

As can be seen with reference to FIG. 7, the core network CN may be divided into several slice instances. Each slice instance may include one or more among a CP function node and a UP function node.

Each UE may use a network slice instance suitable for its own service through an access network (AN).

FIG. 7, each slice instance may share one or more of a CP function node and a UP function node with another slice instance. This will be described with reference to FIG. 7 as follows.

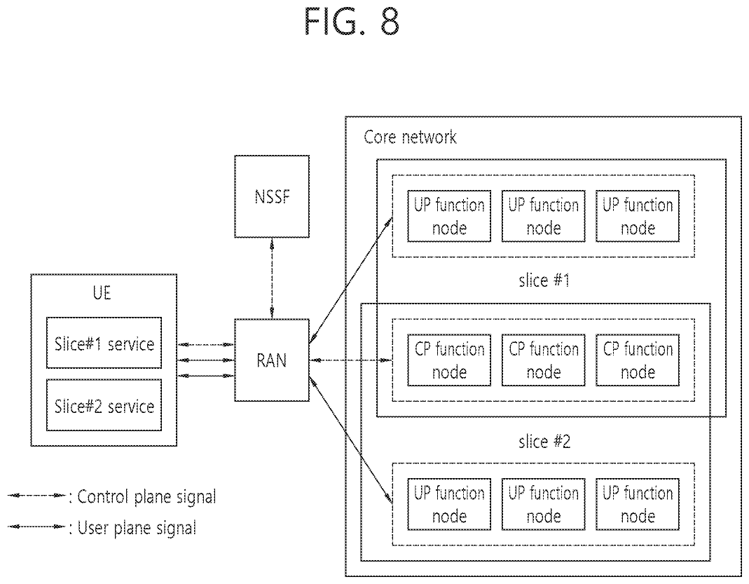

FIG. 8 is an Exemplary Diagram Illustrating Another Example of an Architecture for Implementing the Concept of Network Slicing.

Referring to FIG. 8, a plurality of UP functional nodes are clustered, and similarly, a plurality of CP functional nodes are also clustered.

And, referring to FIG. 8, slice instance #1 (or referred to as instance #1) in the core network includes the first cluster of UP functional nodes. And, the slice instance #1 shares a cluster of CP functional nodes with slice #2 (or called instance #2). The slice instance #2 includes a second cluster of UP functional nodes.

The illustrated Network Slice Selection Function (NSSF) selects a slice (or instance) that can accommodate the service of the UE.

The illustrated UE may use service #1 through the slice instance #1 selected by the NSSF, and may use service #2 through the slice instance #2 selected by the NSSF.

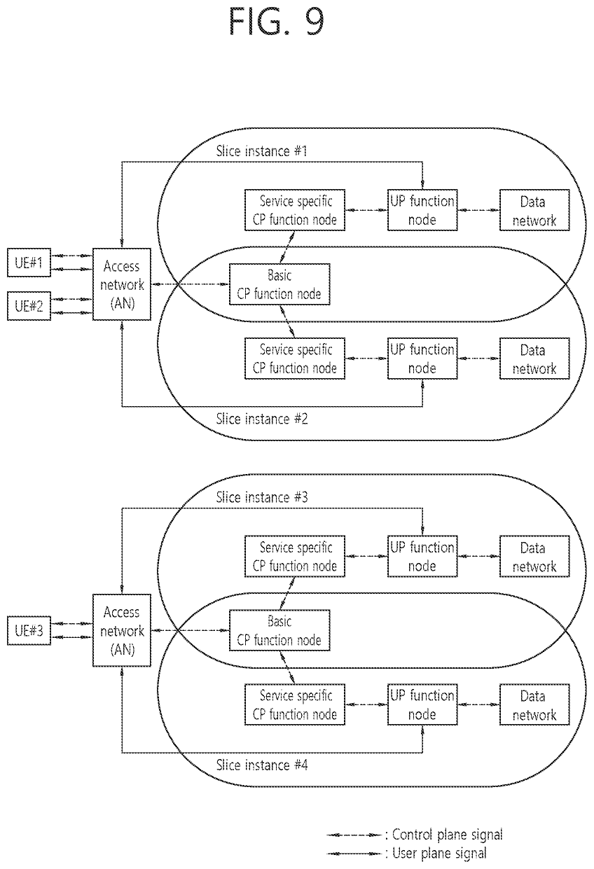

In order for a UE to simultaneously use a plurality of services through a plurality of network slice instances by one network operator, an architecture, which allows a set (or cluster) of CP control nodes to be shared among several slice instances, is proposed. This will be described with reference to FIG. 9 as follows.

FIG. 9 is an Exemplary Diagram Illustrating an Architecture for Implementing the Concept of Network Slicing.

As can be seen with reference to FIG. 9, in order for each UE to use a service through a plurality of slice instances, a basic CP function node may be shared between slice instances.

Each slice instance may include a service-specific CP function node and a UP function node, and a basic CP function node that can be shared with other slice instances.

A plurality of the service-specific CP function nodes may be gathered and bundled into one cluster (i.e., a set). Similarly, a plurality of the UP functional nodes may also be grouped into one cluster (i.e., a set).

Each slice instance may be dedicated for UEs belonging to the same type.

The basic CP function node may allow the UE to enter the network by performing authentication and subscription verification. In addition, the basic CP functional node may manage the mobility of the UE for each characteristic (e.g., low mobility or high mobility, etc.).

The service specific CP function node manages the session.

Meanwhile, when the UE first accesses the operator's network, the basic CP function node is selected in the access network (AN). The selection may be performed according to information of the UE (e.g., usage type of the UE).

If there is a session request from the UE when the UE performs the initial attach or after performing the attaching, the slice instance selection function may be triggered in the core network to select the service specific CP function node and the UP function node. This selection may be performed based on subscriber information and information related to the session request from the UE (e.g., the type of service requested, information such as APN).

When the selection of the service specific CP function node and the UP function node is configured as a default in the core network, the selection may be performed even without a session request from the UE. In this case, if there is a network slice instance configured as a default, it is assigned to the UE.

The UE may have multiple sessions through one slice instance or multiple slice instances. When the UE requests a session, the node in charge of the slice selection function determines which slice instance can support the session requested by the UE. The determined slice instance is assigned for the session.

Meanwhile, the UE may be connected to a plurality of slice instances through different basic CP functional nodes.

On the other hand, the core network may decide to change the default CP function node for the UE for various reasons (e.g., network management problems, UE's subscription information change, UE's location change, etc.). For this, the core network may request a detach/re-attach from the UE. Accordingly, when the UE reconnects to the network, the access network may select another primary CP function node.

<Problems to be Solved in the Disclosure of this Specification>

Through the support of network slices, an operator can classify each service subscriber according to a certain standard or business purpose, and in particular, according to the characteristics of each subscriber group, the operator can provide a service by designating different network slices.

For example, the network may bundle subscribers belonging to a specific campus and may allocate a network slice for them, or may allocate a network slice for communication between a UE group associated with a specific hardware or, for example, UEs mounted on a specific car model. In this case, the specific slice may be used only by users permitted to access the slice.

In this process, the UE (or subscriber, user) may subscribe to several different network slices. For example, a user may subscribe to a network slice A for campus, a slice B assigned to their apartment complex, and a network slice C for the navigation of their vehicle.

In this case, the UE can simultaneously request and use network slices that need to be used according to its activated application.

However, from the perspective of a network that needs to support a large number of users, when a large number of network slices exist, the network may provide a communication network according to the purpose of each network slice. In addition, there may be a requirement to maximize the available time of network slices requested by each UE.

In particular, as the 5G system is advanced and the number of UEs requiring ultra-delay ultra-reliable access such as factory machines increases, the network slice must be available only on a specific frequency or a specific area, or the network must not be affected by other network slices. To this end, the network operator wants each network slice to be available in a specific region or only in a specific region.

In the 5G system, the wireless network and the core network are separated. The UE transmits an access request to the wireless network. Based on the request from the UE, the wireless network determines to which core network the UE's request will be transmitted from among the core networks to which the wireless network is connected. The wireless network transmits the request of the UE to the determined core network. However, if the network elements implementing each network slice are physically separated or do not know each other's information, the core network selected by the wireless network may not properly support the connection request received from the UE or may not provide the service desired by the UE. In particular, such a separated or limited information core network may not recognize that another core network can process the UE's request. In this case, the core network simply sends a rejection message for the request to the UE. This situations should be processed effectively.

With respect to a specific network slice required for a UE to use a service, there are cases in which a core network currently connected or attempting a registration request cannot provide a service for the specific network slice. In this case, in the prior art, the core network simply transmits a rejection message such as registration rejection to the UE, which is inconvenient in efficient communication.

<Disclosure of the Present Specification>

The present specification may provide a method for effectively accessing a network slice (or core network) that the UE wants to receive.

The disclosures described below in this specification may be implemented in one or more combinations (e.g., a combination including at least one of the contents described below). Each of the drawings shows an embodiment of each disclosure, but the embodiments of the drawings may be implemented in combination with each other.

The description of the method proposed in the disclosure of the present specification may consist of a combination of one or more operations/configurations/steps described below. The following methods described below may be performed or used in combination or complementary.

It has been prepared to describe a specific example of the present specification. Since the names of specific devices described in the drawings or the names of specific signals/messages/fields are presented by way of example, the technical features of the present specification are not limited to the specific names used in the following drawings.

### 1. First Disclosure

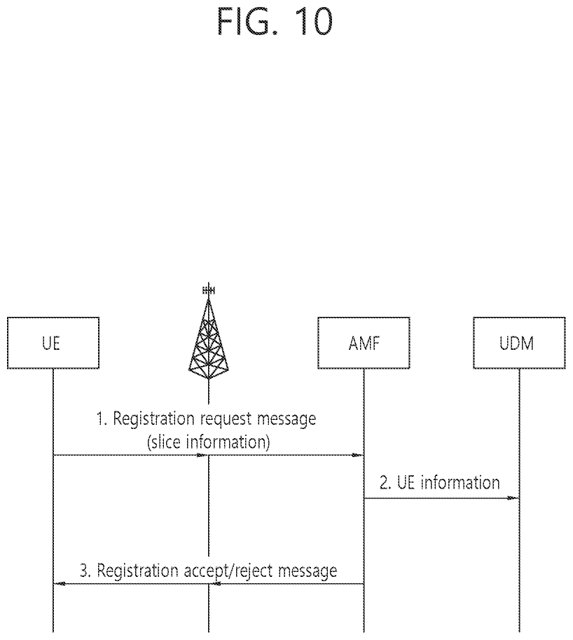

FIG. 10 Shows a First Disclosure of the Present Specification.

1. The UE may send a registration request message to a specific PLMN. The UE may send a registration request message to the base station. The registration request message may include information on network slice(s) desired by the UE. The registration request message may include a request for provision of network slice(s) desired by the UE.

The base station may transmit the registration request message to the AMF of the core network. AMF, which will be described later, may be another network (node).

The AMF may check whether the AMF can provide a network slice which the UE wants to be provided. For this check, the AMF needs subscription information for the UE.

2. The AMF may receive subscription information for the UE from the UDM. When the AMF receives the subscription information for the UE, the AMF may additionally bring information on RAT Frequency Selection Priority (RFSP).

The subscription information may include information about which network slice the UE can use, frequency information, and TA information.

An RFSP applicable to the UE may be stored in the UDM. An RFSP value based on the network slice to which the UE subscribes may be stored in the UDM.

If the UE subscribes to the network slice A and the network slice B, the RFSP for the network slice A and the RFSP for the network slice B may be stored in the UDM. That is, the RFRP may be stored in the UDM for each network slice.

Alternatively, the RFSP for combinations of network slices may be stored. For example, it can be assumed that the RFSP is stored as (x, y, z). At this time, when the UE requests only service for network slice A, the first RFSP value, x, may correspond to service for the network slice A. When the UE requests only service for network slice B, the second RFSP value, y, may correspond to service for the network slice B, when the UE requests only service for both network slice A and network slice B, the third RFSP value, z, may correspond to service for both network slice A and network slice B.

The RFSP value, which is information transmitted from the core network to the base station (gNodeB), etc., may not be directly transmitted to the UE. When the core network sends the RFSP value to the base station, the base station may generate cell selection priority information applicable to the UE based on the RFSP value and transmit it to the UE.

After the AMF receives the subscription information and the RFSP, the AMF may check whether the AMF can provide the UE with the network slices requested by the UE based on the subscription information and the RFSP. That is, the AMF may check whether the AMF can provide the UE with the network slices requested by the UE based on the UE's registration request message, the network slice requested by the UE, and the UE's subscription information. Examples of the case in which the UE cannot receive the service for the corresponding network slice include i) the case where the network slice cannot be provided at the frequency to which the UE is connected, and ii) the case where the AMF cannot provide the network slice.

The subscription information and the RFSP may be network slice support information.

3. The AMF may transmit a registration acceptance or registration rejection message to the base station in response to the registration request message according to result of the check. The base station may transmit the received registration acceptance or registration rejection message to the UE.

If the AMF can provide a service for the network slice requested by the UE as a result of the check, the AMF may transmit a registration acceptance message to the UE through the base station.

On the other hand, if the AMF cannot provide the service for the network slice requested by the UE as a result of the check, the AMF may transmit a registration rejection message to the UE through the base station. However, if the UE requests to provide a plurality of network slices, and the AMF (network) cannot provide only some of them, the AMF may include information indicating that the network slice has been rejected in the registration acceptance message and transmit it to the UE.

That is, while the AMF transmits a response message to base station, information indicating that a request for the network slice is rejected and network slice support information such as RFSP may be included in the response message.

Alternatively, a message indicating AMF rejection and a message including network slice support information may be sent separately by the AMF.

If the AMF has received the RFSP information for the network slice from the UDM, the AMF may transmit the RFSP information to the base station (wireless network). Then, the base station may change or generate information related to cell selection for the UE based on the RFSP information and transmit it to the UE.

When the AMF sends a response message to the base station,

For example, the following information may be stored in the UDM with respect to the UE.
Slice A: RFSP A
Slice B: RFSP B
RSFP A: Freq F1 is high priority, Freq F2 is low priority
RSFP B: Freq F2 is high priority, Freq F1 is low priority

When the UE requests network slice A in the registration process, the AMF may deliver RFSP A to the UE or the NG-RAN. Then, the UE may mainly try to access the frequency F1.

When the UE requests the network slice B in the registration process, the AMF may deliver RFSP B to the UE or the NG-RAN. Then, the UE may mainly try to access the frequency F2.

When the UE requests network slice A at frequency F2 in the registration process, the AMF may deliver RFSP A to the UE or NG-RAN. If the AMF cannot provide the network slice A, the AMF may transmit a registration rejection message to the UE. After that, the UE may try camping on frequency F1 and attempt access. An AMF related to frequency F1 may be selected, and a network node capable of providing network slice A at frequency F1 may be selected.

If the AMF does not receive the RFSP information for the network slice from the UDM, the AMF may additionally transmit information about the network slice and information indicating that the network slice cannot be provided, to the UDM. Then, the UDM may deliver the RFSP information for the network slice to the AMF. The AMF may transmit the RFSP information to the base station (wireless network). Then, the base station may generate information related to cell selection for the UE based on the RFSP information and transmit it to the UE.

### 2. Second Disclosure

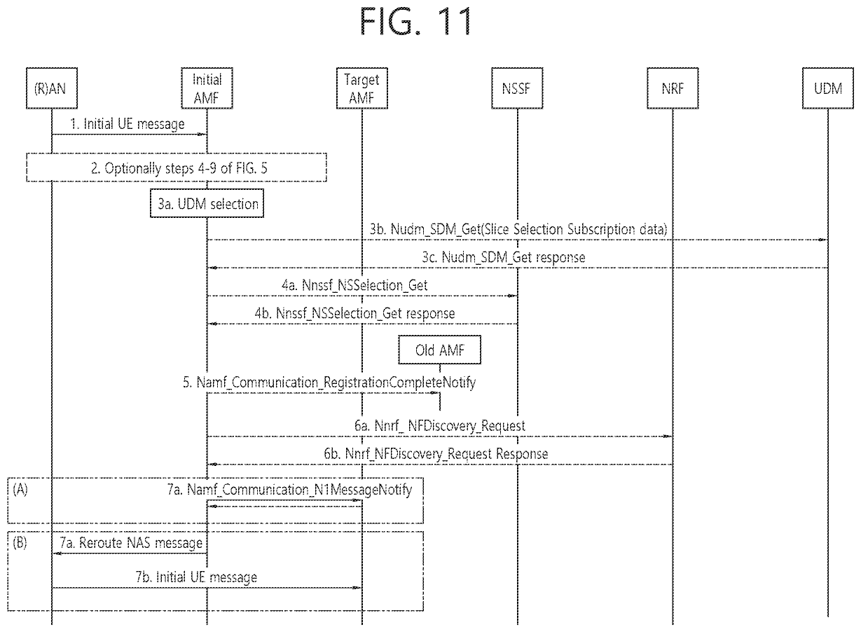

FIG. 11 Shows a Second Disclosure of the Present Specification.

The present specification may provide a method for allowing a network to effectively enable a UE to access a network slice or a core network that the UE wants to receive. In this way, the NSSF (Network Slicing Selection Function) may determine appropriate RFSP information related to the UE based on the information on each region.

0. The UE may transmit a registration request message to the RAN. The RAN may choose AMF.

1. The RAN may send an initial UE message to the initial AMF.

The initial UE message may include a registration request message. When the RAN transmits the initial UE message to the AMF, the RAN may additionally transmit information on which frequency the UE accesses.

2. If the AMF needs the SUPI and/or UE's subscription information to decide whether to reroute the Registration Request or if the Registration Request was not sent integrity protected or integrity protection is indicated as failed, then AMF may perform steps 4 to 9 of FIG. 5 optionally.

3a. [Conditional] If the initial AMF needs UE's subscription information to decide whether to reroute the Registration Request and UE's slice selection subscription information was not provided by old AMF, the AMF selects a UDM.

3b. initial AMF may send Nudm_SDM_Get to the UDM. Nudm_SDM_Get may include SUPI and slice selection subscription data, and the like.

3c. The UDM may respond with network slice selection data to the initial AMF.

The AMF gets the Slice Selection Subscription data including Subscribed S-NSSAIs. The UDM may provide indication that the subscription data for network slicing is updated for the UE.

4a. [Conditional] initial AMF may transmit Nnssf_NSSelection_Get to the NSSF. Nnssf_NSSelection_Get may include Requested NSSAI, mapping of requested NSSAI, subscribed S-NSSAI with default S-NSSAI indication, TAI, allowed NSSAI for other access types (if any), mapping of allowed NSSAI, PLMN ID of SUPI and the like.

If there is a need for slice selection, e.g. the initial AMF cannot serve all the S-NSSAI(s) from the Requested NSSAI permitted by the subscription information, the initial AMF may invoke the Nnssf_NSSelection_Get service operation from the NSSF by including Requested NSSAI, optionally Mapping Of Requested NSSAI, Subscribed S-NSSAIs with the default S-NSSAI indication, Allowed NSSAI for the other access type (if any), Mapping of Allowed NSSAI, PLMN ID of the SUPI and the TAI of the UE. During or after this process, if there is information on RFSP configured in the UE or related information that the AMF receives from UDM, the AMF may transmit the information to the NSSF. In this process, the AMF may deliver information on frequency which the UE connected to the NSSF.

4b. The NSSF may transmit a response message to Nnssf_NSSelection_Get to the initial AMF.

The response message to Nnssf_NSSelection_Get may include AMF set or list of AMF addresses, allowed NSSAI for first access type, allowed NSSAI mapping, allowed NSSAI for second access type, allowed NSSAI mapping, NSI ID(s), NRF (s), List of rejected (S-NSSAI (s), cause value (s)), Configured NSSAI for the Serving PLMN, Mapping Of Configured NSSAI.

The NSSF may return to initial AMF the Allowed NSSAI for the first access type, optionally the Mapping Of Allowed NSSAI, the Allowed NSSAI for the second access type (if any), optionally the Mapping of Allowed NSSAI and the target AMF Set or, based on configuration, the list of candidate AMF(s). The NSSF may return NSI ID(s) associated to the Network Slice instance(s) corresponding to certain S-NSSAI(s). The NSSF may return the NRF(s) to be used to select NFs/services within the selected Network Slice instance(s). It may return also information regarding rejection causes for S-NSSAI(s) not included in the Allowed NSSAI. The NSSF may return Configured NSSAI for the Serving PLMN, and possibly the associated mapping of the Configured NSSAI.

In the above process, in the process of determining the candidate AMF for the UE, the NSSF may additionally determine whether the UE should reconnect in a new area, frequency, or NG-RAN. For example, the NSSF may check whether there is a connection between the NG-RAN currently accessed by the UE and the candidate AMF based on information on the NG-RAN supporting the network slice for each network slice. And if there is no the connection, the NSSF may recognize that reconnection is required in the new NG-RAN.

NOTE: The NRF(s) returned by the NSSF, if any, belong to any level of NRF according to the deployment decision of the operator.

In this process, if there is an RFSP or related information configured for the UE received from the AMF, the NSSF may consider it. Alternatively, the NSSF may use an RFSP pre-configured to itself or related information. Here, the RFSP or the related information may be information on a region or frequency in which the network slice is provided for each network slice.

In this process, the NSSF may check other TA or cell information or frequency adjacent to the TA or cell based on regional information which the UE is currently accessed (for example, TA information, or cell information or frequency). Then the NSSF may check whether the network slice requested by the UE can be provided. Based on this, in order to provide the network slice requested by the UE, information on which TA or cell or frequency to which the UE should access may be configured. This information may be forwarded to the AMF. For example, RSFP or similar information is transmitted.

5. [Conditional] Namf_Communication_RegistrationCompleteNotify can be transmitted from the initial AMF to the old AMF. Namf_Communication_RegistrationCompleteNotify may include information on a cause of failure.

The initial AMF decides to reroute the NAS message to another AMF. The initial AMF sends a reject indication to the old AMF telling that the UE Registration procedure did not fully complete at the initial AMF. The old AMF continues as if the Namf_Communication_UEContextTransfer had never been received.

If the NSSF informs that the UE needs reconnection in anew area/NG-RAN, etc., the AMF may omit the following step, may instruct the UE to reconnect in the new area and new frequency, and may transmit a registration rejection message. In addition, a certain method may be additionally used to allow the UE to move to the target NG-RAN or new frequency. Alternatively, when the NSSF transmits RFSP or similar information, the AMF may use it to transmit to the UE or to the NG-RAN.

6a. [Conditional] Nnrf_NFDiscovery_Request may be transmitted from the initial AMF to the NRF. Nnrf_NFDiscovery_Request may include NF type and AMF set.

If the initial AMF does not locally store the target AMF address, and if the initial AMF intends to use direct reroute to target AMF or the reroute via (NG-R)AN message needs to include AMF address, then the initial AMF may invoke the Nnrf_NFDiscovery_Request service operation from the NRF to find a proper target AMF which has required NF capabilities to serve the UE. The NF type is set to AMF. The AMF Set is included in the Nnrf_NFDiscovery_Request.

6b. [Conditional] A response message to Nnrf_NFDiscovery_Request may be transmitted from NRF to AMF. The response message to Nnrf_NFDiscovery_Request may include a list (AMF pointer, AMF address, additional selection rule and NF function addition).

The NRF replies with the list of potential target AMF(s). The NRF may also provide the details of the services offered by the candidate AMF(s) along with the notification end-point for each type of notification service that the selected AMF had registered with the NRF, if available. As an alternative, it provides a list of potential target AMFs and their capabilities, and optionally, additional selection rules. Based on the information about registered NFs and required capabilities, a target AMF is selected by the initial AMF.

If the initial AMF is not part of the target AMF set, and is not able to get a list of candidate AMF(s) by querying the NRF with the target AMF set (e.g., the NRF locally pre-configured on AMF does not provide the requested information, the query to the appropriate NRF provided by the NSSF is not successful, or the initial AMF has knowledge that the initial AMF is not authorized as serving AMF etc.) then the initial AMF shall forward the NAS message to the target AMF via (R)AN executing step 7(B); the Allowed NSSAI and the AMF Set may be included to enable the (R)AN to select the target AMF.

7(A). If the initial AMF, based on local policy and subscription information, decides to forward the NAS message to the target AMF directly, the initial AMF invokes the Namf_Communication_N1MessageNotify to the target AMF, carrying the rerouted NAS message. The Namf_Communication_N1MessageNotify service operation includes the information enabling (R)AN to identify the N2 terminating point and the NAS message carried at step 1, and the UE's SUPI and MM Context if available. If the initial AMF has obtained the information from the NSSF as described at step 4b, that information except the AMF Set or list of AMF addresses is included. The target AMF then updates the (R)AN with a new updated N2 termination point for the UE in the first message from target AMF to RAN.

7(B). If the initial AMF, based on local policy and subscription information, decides to forward the NAS message to the target AMF via (R)AN unless the target AMF(s) are returned from the NSSF and identified by a list of candidate AMF(s), the initial AMF sends a Reroute NAS message to the (R)AN (step 7a). The Reroute NAS message includes the information about the target AMF and the Registration Request message carried at step 1 or resent at step 2 as defined in TS 24.501 [25]. If the initial AMF has obtained the information as described at step 4b, that information is included. The (R)AN sends the Initial UE message to the target AMF (step 7b) indicating reroute due to slicing including the information from step 4b that the NSSF provided.

That is, the NSSF may additionally utilize frequency information configured to be provided by each slice or each AMF in the process of determining a network slice that can be provided to the UE and selecting an AMF related thereto. To this end, the NSSF acquires association information/restriction information with each TA/Cell/Slice/frequency through another node or configuration. Based on this, the NSSF may check whether the network slice requested from the UE can be provided at the current frequency, and if the network slice should be provided at other frequency, the NSSF may notify to AMF/NG-RAN/UE, etc. Then the corresponding UE may try to access at the other frequency.

### 3. Third Disclosure

The UE may transmit a registration request message to the network. The registration request message may include information (or provision request) on the network slice for the service requested by the UE.

The network (e.g., AMF) may not be able to provide the UE with the network slice requested by the UE. In this case, the network may send a registration rejection message to the UE. Alternatively, the network may include information indicating that it cannot provide for the corresponding network slice in the response message to the UE.

UDM, NSSF, or AMF may directly transmit information about which frequency the UE should preferentially try, to the UE, together with a response message. That is, it is a method of delivering an RFSP related to a network slice or information related thereto (hereinafter referred to as S-RFSP; Slice-RFSP) to the UE. There are various methods of configuring information of this S-RFSP, and it is mainly information on which frequency the UE should preferentially camp on.

For example, the UDM may configure S-RFSP information for each network slice, put it in a container, and request the AMF to transmit it to the UE. The AMF may deliver this information to the UE using NAS transport or the like.

For example, the response message may be extended as shown in Table 3.

TABLE 3

| | Information | Type/ | | | |
|---|---|---|---|---|---|
| EI | Element | Reference | Presence | Format | Length |
| | Extended | Extended | M | V | 1 |
| | protocol | protocol | | | |
| | discriminator | discriminator 9.2 | | | |
| | Security | Security | M | V | ½ |
| | header | header | | | |
| | type | type9.3 | | | |
| | Spare half | Spare half | M | V | ½ |
| | octet | octet 9.5 | | | |
| | Registration | Message | M | V | 1 |
| | reject | type 9.7 | | | |
| | message | | | | |
| | identity | | | | |
| | 5GMM | 5GMM | M | V | 1 |
| | cause | cause9.11.3.2 | | | |
| 5F | T3346 | GPRS timer | O | TLV | 3 |
| | value | 29.11.2.4 | | | |
| 16 | T3502 | GPRS timer | O | TLV | 3 |
| | value | 29.11.2.4 | | | |
| 78 | EAP | EAP | O | TLV-E | 7-1503 |
| | message | message9.11.2.2 | | | |
| 69 | Rejected | | O | TLV | 4-42 |
| | NSSAI | | | | |
| XX | Dedicated | RAT Frequency | | | |
| | S-RFSP | Selection info | | | |

Referring to Table 3, the “Dedicated S-RFSP” field corresponds to S-RFSP information for each network slice included in the response message. The UE may receive a plurality of S-RFSP information. When the UE receives a plurality of S-RFSP information, the UE may determine whether to use specific S-RFSP information based on the network slice that the UE intends to use. The determined S-RSFP information may be delivered to the lower layer. Conversely, if one piece of S-RFSP information is received, the UE may transmit the received S-RSFP information to a lower layer. The lower layer receiving this may preferentially use it rather than the information received through the RRC message or SIB. The base station (gNodeB) may transmit RFSP information to all UEs through the SIB message. After that, when the RFSP information is transmitted to the UE by the NAS message, the RFSP by the NAS message may take precedence over the RFSP information by the SIB message.

The aforementioned S-RSFP information may be configured by AMF/NSSF instead of UDM. That is, the AMF may configure the S-RFSP corresponding to the network slice requested by the UE based on the information received from the UDM and deliver it to the UE. Alternatively, the NSSF may request the AMF to configure the S-RFSP information based on its own information and to transmit it to the UE.

The absolute priority of different NR frequencies or inter-RAT frequencies may be provided to the UE by inheriting from system information, in RRC Release messages, or other RAT in inter-RAT cell (re)selection. In the case of system information, an NR frequency or an inter-RAT frequency may be listed without providing a priority (i.e., there is no field cellReselectionPriority for the corresponding frequency). If priority is provided in dedicated signaling, the UE shall ignore all priorities provided in system information. When the UE is in any cell state, the UE shall apply only the priority provided by the system information of the current cell. And unless otherwise specified, the UE shall keep the priority provided by the dedicated signaling and deprioritisationReq received in the RRC Release. When the UE in the camped steady state has only a dedicated priority other than the current frequency, the UE shall regard the current frequency as the lowest priority frequency (i.e., lower than any of the network configuration values).

When the NAS layer receives the S-RFSP information, the NAS delivers the related S-RFSP information to the lower layer (e.g., RRC). When the UE receives the S-RFSP information from the NAS layer, the UE may delete the cellReselectionPriority information received from the SIB or RRC Release message or may release the priority.

The UE shall perform cell reselection evaluation only for NR frequencies and inter-RAT frequencies which is provided in the system information, wherein the UE provides priority on the NR frequencies and inter-RAT frequencies.

When the UE receives an RRC Release with deprioritizationReq, the UE considers all frequencies of the previously received RRC Release with deprioritisationReq or NR as the lowest priority frequency T325 (that is, lower than the network configuration value). Then the UE should take into account for the current frequency and stored frequencies. The above action is performed regardless of the camped RAT. The UE shall delete the stored priority removal request(s) when PLMN selection is performed according to the request of the NAS.

Note 1: The UE should search for a higher priority layer for cell reselection as soon as possible after the priority change.

### 4. Fourth Disclosure

In the present specification, it is possible to provide a method of including regional information in addition to information such as RFSP or related cellReselectionPriority in a response message transmitted from the network to the UE. That is, the RFSP-related information (or RFSP information generated by other NFs, or other information) stored by the UDM may additionally include local information (e.g., cell information, TA information, or geolocation information). Based on this, cellReselectionPriority or similar information transmitted to the UE through RRC or NAS may additionally include related area information. That is, cellReselectionPriority is transmitted to several UEs and each corresponding region information may be used. The UE may determine the region in which it is located and use the related cellReselectionPriority. The network may control which frequency the UE mainly uses for each region.

The region information may be additionally applied to the first disclosure, the second disclosure, and/or the third disclosure described above.

The details are as follows.

1. First, in UDM (or NEF, PCF, AMF, etc.), information on which frequency, region information, or which RAT can provide a service may be collected for each application, UE, and network slice.

The UE may receive input information from the user and transmit it to the AMF. Then, the AMF may be transmitted to the UDM (or PCF, etc.). In the application server, through NEF/PCF, etc., information is transmitted, and this content may be stored in UDM or the like.

2. The UE may transmit information on network slices (or applications, PDU sessions) required by the UE to the network (AMF) through a registration process (or PDU session establishment process).

3a. In step 2, the AMF acquires information related to the information on the network slice (or application) requested by the UE from the UDM. After determining which network slice among the network slices requested by the UE is allowed, the AMF may obtain information on a preferred frequency, preferred region, or RAT for each network slice from UDM. Based on this, the UE may determine in which region/RAT/frequency to camp and transmit it to the UE or the base station (wireless network).

3b. Instead of step 3a above, whenever the UE creates every PDU session, the AMF (or SMF) may retrieve information about the network slice mapped to each PDU session from the UDM. The AMF may deliver the information to the NG-RAN.

4. Based on the information in steps 3a and 3b, the radio network may determine which data bearer is provided at which radio frequency/RAT in radio bearer setup with the UE. For example, if PDU session A and PDU session B are configured for network slice A and network slice B, respectively, frequency/RAT/region that can receive service and service for each network slice (PDU session) may be provided. The wireless network may deliver information on frequencies/RATs/regions that cannot be reached to the UE. In this process, the wireless network may determine which bearer to provide in which frequency/RAT/region, and may deliver it to the UE.

Policy information on which frequency/region/RAT should be used for each network slice (or each application) is stored in the UE, and the UE may operate based on this.

For example, information such as Freq A for application A (or network slice A) and Freq B for application B (or network slice B) may be stored in the UE. Thereafter, based on the activated network slice (or application), the UE may determine in which frequency/region/RAT to camp on.

URSP is shown in Table 4.

TABLE 4

| | | | PCF | |
|---|---|---|---|---|
| | | | permitted | |
| Information | | | to modify | |
| name | Description | Category | in a URSP | Scope |
| URSP rules | 1 or more URSP | Mandatory | Yes | UE |
| | rules as | | | context |
| | specified in | | | |
| | table 5 | | | |

URSP rules is shown in Table 5.

TABLE 5

| | | | PCF permitted to | |
|---|---|---|---|---|
| Information | | | modify in a | |
| name | Description | Category | UE context | Scope |
| Rule Precedence | Determines the order the URSP | Mandatory | Yes | UE context |
| | rule is enforced in the UE. | (NOTE 1) | | |
| Traffic descriptor | This part defines the Traffic | Mandatory | | |
| | descriptor components for the URSP rule. | (NOTE 3) | | |
| Application descriptors | It consists of OSId | Optional | Yes | UE context |
| | and OSAppId(s). (NOTE 2) | | | |
| IP descriptors | Destination IP 3 tuple(s) | Optional | Yes | UE context |
| (NOTE 5) | (IP address or IPv6 network | | | |
| | prefix, port number, protocol | | | |
| | ID of the protocol above IP). | | | |
| Domain descriptors | Destination FODN(s) | Optional | Yes | UE context |
| Non-IP descriptors | Descriptor(s) for destination | Optional | Yes | UE context |
| (NOTE 5) | information of non-IP traffic | | | |
| DNN | This is matched against the | Optional | Yes | UE context |
| | DNN information provided | | | |
| | by the application. | | | |
| Connection | This is matched against | Optional | Yes | UE context |
| Capabilities | the information provided | | | |
| | by a UE application when it | | | |
| | requests a network connection | | | |
| | with certain capabilities. (NOTE 4) | | | |
| List of Route | A list of Route Selection Descriptors. | Mandatory | | |
| Selection | The components of a Route Selection | | | |
| Descriptors | Descriptor are described in table 6.6.2.1-3. | | | |

NOTE 1:
Rules in a URSP shall have different precedence values.
NOTE 2:
The information is used to identify the Application(s) that is(are) running on the UE's OS. The OSId does not include an OS version number. The OSAppId does not include a version number for the application.
NOTE 3:
At least one of the Traffic descriptor components shall be present.
NOTE 4:
The format and some values of Connection Capabilities, e.g. “ims”, “mms”, “internet”, etc., are defined in TS 24.256 [19]. More than one connection capabilities value can be provided.
NOTE 5:
A URSP rule cannot contain the combination of the Traffic descriptor components IP descriptors and Non-IP descriptors.

The route selection descriptor is shown in Table 6.

TABLE 6

| | | | PCF | |
|---|---|---|---|---|
| Information | | | permitted to | |
| name | Description | Category | modify in URSP | Scope |
| Route | Determines the order in | Mandatory | Yes | UE context |
| Selection | which the Route Selection | (NOTE 1) | | |
| Descriptor | Descriptors are to be | | | |
| Precedence | applied. | | | |
| Route | This pan defines the route | Mandatory | | |
| selection | selection components | (NOTE 2) | | |
| components | | | | |
| SSC Mode | One single value of SSC | Optional | Yes | UE context |
| Selection | mode. (NOTE 5) | | | |
| Network | Either a single value or a list | Optional | Yes | UE context |
| Slice | of values of S-NSSAI(s). | (NOTE 3) | | |
| Selection | | | | |
| DNN | Either a single value or a list | Optional | Yes | UE context |
| Selection | of values of DNN(s). | | | |
| PDU Session | One single value of PDU | Optional | Yes | UE context |
| Type | Session Type | (NOTE 8) | | |
| Selection | | | | |
| Non- | Indicates if the traffic of the | Optional | Yes | UE context |
| Seamless | matching application is to | (NOTE 4) | | |
| Offload | be offloaded to non-3GPP | | | |
| indication | access outside of a PDU | | | |
| | Session. | | | |
| Access Type | Indicates the preferred | Optional | Yes | UE context |
| preference | Access Type (3GPP or non- | | | |
| | 3GPP or Multi-Access) | | | |
| | when the UE establishes a | | | |
| | PDU Session for the | | | |
| | matching application. | | | |
| RAT and | List of RAT and/or | | | |
| Frequency | Frequency list applicable to | | | |
| components | above components | | | |
| Route | This part defines the Route | Optional | | |
| Selection | Validation Criteria | | | |
| Validation | components | | | |
| Criteria | | | | |
| (NOTE 6) | | | | |
| Time | The time window when the | Optional | Yes | UE context |
| Window | matching traffic is allowed. | | | |
| | The RSD is not considered | | | |
| | to be valid if the current | | | |
| | time is not in the time | | | |
| | window. | | | |
| Location | The UE location where the | Optional | Yes | UE context |
| Criteria | matching traffic is allowed. | | | |
| | The RSD rule is not | | | |
| | considered to be valid if the | | | |
| | UE location does not match | | | |
| | the location criteria. | | | |

NOTE 1:
Every Route Selection Descriptor in the list shall have a different precedence value.
NOTE 2:
At least one of the route selection components shall be present.
NOTE 3:
When the Subscription Information contains only one S-NSSAI in UDR, the PCF needs not provision the UE with S-NSSAI in the Network Slice Selection information. The “match all” URSP rule has one S-NSSAI at most.
NOTE 4:
If this indication is present in a Route Selection Descriptor, no other components shall be included in the Route Selection Descriptor.
NOTE 5:
The SSC Mode 3 shall only be used when the PDU Session Type is IP.
NOTE 6:
The Route Selection Descriptor is not considered valid unless all the provided Validation Criteria are met.
NOTE 7:
In this Release of specification, inclusion of the Validation Criteria in Roaming scenarios is not considered.
NOTE 8:
When the PDU Session Type is “Ethernet” or “Unstructured”, this component shall be present.

Information on which frequency/RAT should be used for each RSD may be provided to the UE. The UE may attempt to access/data transmission in RSD priority, and at this time, request that the corresponding RSD according to the RAT and frequency information be provided. For example, when the RSD includes RAT/frequency information as well as N-SSAI information for data satisfying a certain traffic descriptor, in data transmission or PDU session request for the data, the UE may perform in the RAT/frequency. In addition, the information shown in Table 7 may be managed by the UE separately from the URSP.

TABLE 7

| | | | PCF | |
|---|---|---|---|---|
| | | | permitted | |
| Information | | | to modify in | |
| name | Description | Category | a UE context | Scope |
| Traffic | This part defines | Mandatory | | |
| descriptor | the Traffic | (NOTE 3) | | |
| | descriptor | | | |
| | components for | | | |
| | the URSP rule. | | | |
| Network | Network slice | Optional | Yes | UE context |
| slice | | | | |
| descriptors | | | | |
| RF policy | | | | |
| RAT and | List of RAT | | | |
| Frequency | and/or | | | |
| components | Frequency list | | | |
| | applicable | | | |
| | to above | | | |
| | components | | | |

Information on which RAT/frequency to use for each network slice may be stored in the UE. When it is determined which application should use which network slice according to the URSP, the UE may determine which RAT/frequency to use for a specific network slice based on this. Based on this, the UE may transmit data or request a PDU session. The UE may use it for PLMN/RAT/frequency selection. That is, according to the activated network slice (or application), using the information in Tables 5, 6, and 7, the UE may determine the PLMN/frequency/RAT to camp on and operate accordingly.

This method may be applied to EPS/5GS and the like. The name of the message or the name of the entity may be applied thereto and adjusted.

### 5. Fifth Disclosure

The present specification may provide a method of having a dedicated NF constituting information for an RFSP or similar purpose. Conventionally, RFSP or similar purpose information is configured in UDM, AMF, NSSF, etc. and transmitted to other network nodes. In this specification, is configured, this specification provides a method to configure a related node (for example, RMF: Let's call it an RFSP Management Function), and configure RFSP.

When the AMF cannot properly provide the network slice(s) requested by the UE, the AMF may deliver information on the network slice(s) requested by the UE to the RMF. To provide the network slice(s) to the UE, the RMF may configure an RFSP to be applied to the UE. The RMF may transmit the RFSP to the AMF, and the AMF may deliver the RFSP to the NG-RAN. The NG-RAN may transmit an RFSP to the UE, so that the NG-RAN may control the frequency selection and cell selection of the UE.

The operation of the RMF may be performed in the PCF. That is, the AMF may select a PCF that processes RFSP-related reconfiguration in the PCF selection process for the UE, and transmit the network slice related information requested by the UE. The PCF may configure the RFSP related to the network slice or information for a similar purpose to the UE and transmit it to the AMF. Based on this, the AMF may deliver the RFSP, etc. to the UE or the NG-RAN.

### 6. Sixth Disclosure

The UE may transmit a registration request message to the network. The registration request message may include information (or provision request) on the network slice for the service requested by the UE.

If the network (e.g., AMF) may not be able to provide the UE with the network slice requested by the UE. The network may send a response message to the UE. The response message may include information indicating that the network rejects the UE's request for provision of the network slice.

The AMF may transmit information on the network slice that the UE requested but could not be provided by the AMF along with the response message to the NG-RAN. Based on the information, the NG-RAN may transmit information related thereto to the UE if the network slice can be provided in its surrounding area or at a frequency nearby. For example, information on which region/TA/frequency is available may be transmitted for each network slice.

The UE may receive a response message from the network. When the UE receives the information on the network slice provided in the surrounding area/TA/frequency from the NG-RAN as described above, the RRC layer may notify the NAS layer. The NAS layer may inform the RRC of information on the network slice it wants to receive based on the information provided by the RRC layer. Based on the information received from the NAS layer, the RRC layer may perform transition to the corresponding area/TA/frequency and notify the NAS layer of this. Based on this, the NAS layer may try to register in a new region.

The UE may receive the reason for rejection of the provision request through the response message. For example, the network may transmit a reason such as ‘try other frequency’, ‘redirection to other frequency’ or a reason for rejection for a similar purpose to the UE. Based on this, the UE may select another frequency and attempt network registration at the new frequency. In this case, even if the quality of the current cell is good, the UE may move to the frequency if the quality of another frequency in the vicinity satisfies a certain level.

The NG-RAN may transmit an SIB message to the UE. The SIB message may include information on neighboring cells and additionally information on TAs to which the neighboring cells belong. For example, as described above, when the UE recognizes that another TA exists in a neighboring frequency based on the information in the SIB, a UE, which has not been provided with a service for a desired network slice due to frequency or other issues, may move to the frequency and start the registration procedure.

(1) Index of RAT/Frequency Selection Priority

The AMF may transmit information about the network slice to the NG-RAN by using the index of the RAT/frequency selection priority.

Table 8 shows the index of RAT/frequency selection priority.

TABLE 8

| | | | | |
|---|---|---|---|---|
| IE/Group | | | IE type and | Semantics |
| Name | Presence | Range | reference | description |

| | | | |
|---|---|---|---|
| List of Index to | | | |
| RAT/Frequency | | | |
| Selection Priority | | | |
| >Index to | M | INTEGER | |
| RAT/Frequency | | (1 . . . 256, . . .) | |
| Selection Priority | | | |
| >>related | | | S-NSSAI, |
| slice info | | | NSSAI |

The AMF may transmit a list for the RAT/frequency selection priority index to the NG-RAN. In addition, the AMF may transmit information on the network slice identifier to the NG-RAN. The AMF may transmit information on each network slice to the NG-RAN.

This IE is used to define local configurations for RRM strategies such as camp priority in idle mode and RAT/inter-frequency handover control in active mode.

(2) Downlink NAS Transport

The AMF may transmit NAS information to the NG-RAN through the NG interface.

Table 9 shows information transmitted from the AMF to the NG-RAN.

TABLE 9

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Message Type | M | 9.3.1.1 | | YES | ignore |
| AMF UE NGAP | M | 9.3.3.1 | | YES | reject |
| ID | | | | | |
| RAN UE NGAP | M | 9.3.3.2 | | YES | reject |
| ID | | | | | |
| Old AMF | O | AMF Name9.3.3.21 | | YES | reject |
| RAN Paging | O | 9.3.3.15 | | YES | ignore |
| Priority | | | | | |
| NAS-PDU | M | 9.3.3.4 | | YES | reject |
| Mobility | O | 9.3.1.85 | | YES | ignore |
| Restriction List | | | | | |
| Index to | O | 9.3.1.61 | | YES | ignore |
| RAT/Frequency | | | | | |
| Selection Priority | | | | | |
| UE Aggregate | O | 9.3.1.58 | | YES | ignore |
| Maximum Bit Rate | | | | | |
| Allowed NSSAI | O | 9.3.1.31 | Indicates the S- | YES | reject |
| | | | NSSAIs | | |
| | | | permitted by | | |
| | | | the network. | | |
| List of Rejected | | | Indicates the S- | | |
| NSSAI | | | NSSAIs | | |
| | | | rejected in core | | |
| | | | network due to | | |
| | | | out of TA | | |
| | | | where the | | |
| | | | service is | | |
| | | | provided | | |
| >S-NSSAI | | | | | |
| >> | | | Cause of reject | | |

The information transmitted to the NG-RAN may include an identifier NSSAI specific to the rejected network slice and a reason for rejection. For example, it may be outside an area that can provide a service. In addition to downlink NAS transport, a message such as a UE context release command may be used.

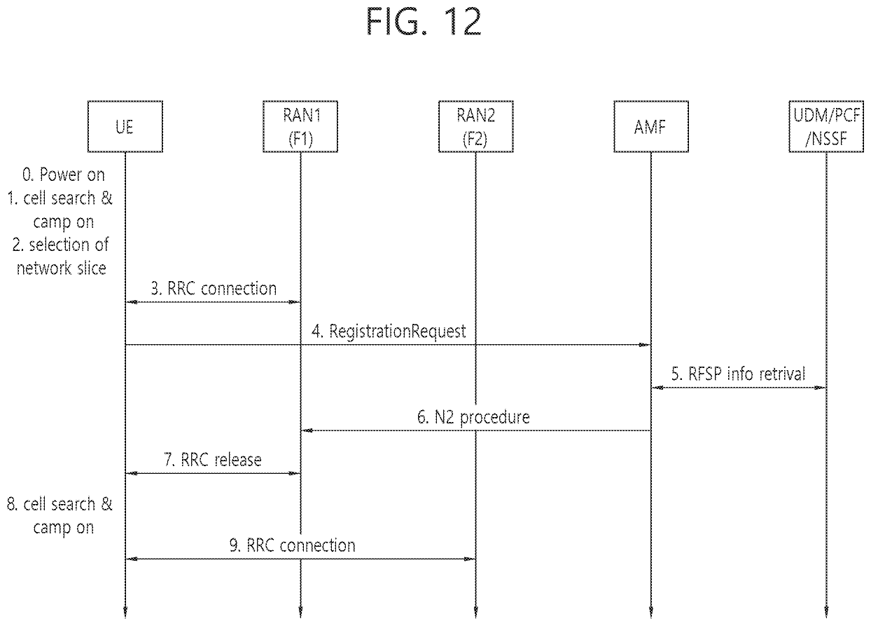

FIG. 12 Shows a Sixth Disclosure of the Present Specification.

0. The present specification provides an effective communication method to a powered-on UE. It is not limited to the UE that is turned on, and it may be applied to all situations in which the UE searches for a cell, camps on, and selects a network slice, such as when the UE moves from an area where communication is impossible to an area where communication is possible.

1. The UE may search for a cell to camp on. As a result of the search, a cell with a good signal may be selected.

2. The UE may determine specific network slices the UE needs according to application requirements.

3. The UE may establish an RRC connection with RAN1 through the cell selected in step 1.

4. When the RRC connection is established, the UE may transmit a registration request message to the AMF. The registration request message may include information (or provision request) of specific network slices determined in step 2.

5. AMF may obtain RFSP information from network nodes such as UDM/PCF/NSSF when receiving a registration request message from the UE. In this process, information on the network slice requested by the UE, the identifier of the UE, the current location of the UE, the current frequency of the UE, the network slice to which the UE subscribes, information on network slices installed in the network, etc. may be utilized.

RFSP information may be stored in the UDM. The AMF may receive RFSP information from the UDM. Alternatively, the AMF may receive RFSP information from the UDM through the PCF.

The AMF may determine a frequency or a radio node to which the UE can connect to a specific network slice based on the obtained RFSP information. According to the determined frequency or radio node, the AMF may determine whether AMF can provide a service to the UE for a specific network slice requested by the UE or not. That is, the AMF (network) may determine whether the AMF can provide the service for the corresponding network slice to the UE based on the registration request message of the UE, the network slice requested by the UE, and subscription information of the UE.

6. Based on the determined frequency or radio node, the AMF may transmit the RFSP value (or target network slice support information to be provided to the UE, etc.) to be applied to the UE to the radio RAN1 to which the UE is currently connected. The RFSP value may be configured for each network slice. That is, an RFSP value for each network slice may be transmitted.

7. If the RAN1 or the network (AMF) cannot provide the network slice requested by the UE, the AMF may transmit, to the RAN1, a response message including information indicating that the request for providing the corresponding network slice is rejected. The response message may include information on the RFSP value for each network slice described above.

Considering information received along with the response message, radio capability of the UE, available cells nearby, frequency information, information of a network slice required by the UE and the like, RAN1 may create information related to cell selection (cell reselection priority). In addition, the RAN1 may transmit to the UE information related to cell selection (cell reselection priority) and information indicating that a request for providing a corresponding network slice is rejected. The cell selection priority information may include information to preferentially select RAN2 (frequency F2).

In addition, RAN1 may release the RRC connection with the UE.

8. When the RRC connection with RAN1 is disconnected, the UE may search for a cell and camp on the cell. In this case, the UE may use cell reselection priority information received from RAN1. For example, if the frequency F2 is configured to be preferred, a cell corresponding to RAN2 may be selected and camped on.

9. The UE may establish an RRC connection with RAN2. Thereafter, the UE may transmit, to the new AMF, a registration request message, including information on network slices that the UE wants to receive service from the network again.

In the above, RSFP is an example, and may be applied to other information for a similar purpose.

RAN1 and RAN2 may correspond to base stations as wireless networks.

This specification is applicable to EPS/5GS, etc., and the name of the message or the name of the entity may be adjusted and applied thereto.

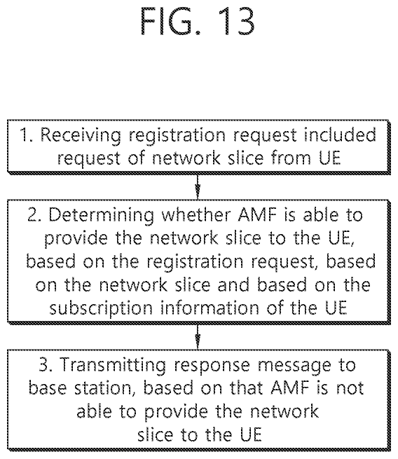

FIG. 13 Shows the Procedure of AMF in the Sixth Disclosure of the Present Specification.

1. The UE may transmit a registration request message to the network (e.g., AMF). The registration request message may include information or a request for provision of specific network slices required by the UE by an application or the like.

2. The network (AMF) determines whether the network (e.g., AMF) can provide the UE with a service for the corresponding network slice based on the registration request message of the UE, the network slice requested by the UE, and the subscription information of the UE.

The network (e.g., AMF) may obtain RFSP information from a network node such as UDM/PCF/NSSF. In this process, information on the network slice requested by the UE, the identifier of the UE, the current location of the UE, the current frequency of the UE, the network slice to which the UE subscribes, information on network slices installed in the network, etc. may be utilized.

RFSP information may be stored in the UDM. The network (e.g., AMF) may receive RFSP information from the UDM. Alternatively, the network (e.g., AMF) may receive RFSP information from the UDM through the PCF.

The network (e.g., AMF) may determine a frequency or a radio node to which the UE can connect to a specific network slice based on the obtained RFSP information. That is, according to the determined frequency or radio node, the network (e.g., AMF) may determine whether it can provide a service to the UE for a specific network slice requested by the UE.

3. If the network (e.g., AMF) cannot provide the network slice requested by the UE, the network (e.g., AMF) may transmit a response message to the base station. The response message may include information indicating that the UE's request for a specific network slice is rejected.

Complexly considering information received along with the response message, radio capability of the UE, available cells around, frequency information, information of a network slice required by the UE, and the like, the base station may create information related to cell selection (cell reselection priority).

The base station may transmit to the UE information related to cell selection (cell reselection priority) and information indicating that the UE's request for a specific network slice is rejected. The information related to cell selection may include information to preferentially select another frequency or another wireless Internet.

The subsequent operation is the same as that described with reference to FIG. 12.

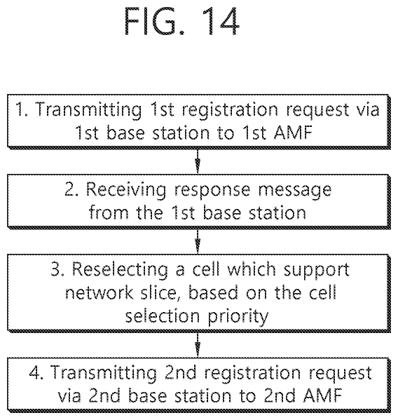

FIG. 14 Shows a Procedure of the UE in the Sixth Disclosure of the Present Specification.

1. The UE may transmit a registration request message to the network (e.g., AMF). The registration request message may include information or a request for provision of specific network slices required by the UE by an application or the like.

The network (e.g., AMF) may acquire RFSP information from a network node such as UDM/PCF/NSSF upon receiving a registration request message from the UE. In this process, information on the network slice requested by the UE, the identifier of the UE, the current location of the UE, the current frequency of the UE, the network slice to which the UE subscribes, information on network slices installed in the network, etc. may be utilized.

RFSP information may be stored in the UDM. The network (e.g., AMF) may receive RFSP information from the UDM. Alternatively, the network (e.g., AMF) may receive RFSP information from the UDM through the PCF.

The network (e.g., AMF) may determine a frequency or a radio node to which the UE can connect to a specific network slice based on the obtained RFSP information. That is, according to the determined frequency or radio node, the network (e.g., AMF) may determine whether it can provide a service to the UE for a specific network slice requested by the UE. That is, the network (AMF) may determine whether the network (e.g., AMF) can provide a service for the corresponding network slice to the UE based on the registration request message of the UE, the network slice requested by the UE, and the subscription information of the UE.

2. If the network (e.g., AMF) cannot provide the network slice requested by the UE, the UE may receive a response message from the base station. The response message may include information indicating that the UE's request for a specific network slice is rejected.

The response message may include information related to cell selection related to a specific network slice.

Complexly considering information received along with the response message, RFSP information, radio capability of the terminal, available cells in the vicinity, frequency information, information of a network slice required by the UE, etc. reselection priority), the base station may create a cell selection related information (cell reselection priority). In addition, the base station may transmit the cell selection related information (cell reselection priority) to the UE. The cell selection priority information may include information for preferentially selecting another frequency or another wireless Internet.

3. The UE may reselect a cell supporting a specific network slice based on the cell selection priority information.

Based on the content of the cell selection priority information, the UE may reselect a new cell other than the existing cell.

4. The UE may transmit a registration request message to anew network (e.g., AMF) through the base station serving the reselected cell.

The specification may have various effects.

For example, through the procedure disclosed in the present specification, the UE can effectively connect to a network slice required for the UE and receive a service.

Effects that can be obtained through specific examples of the present specification are not limited to the effects listed above. For example, various technical effects that a person having ordinary skill in the related art can understand or derive from this specification may exist. Accordingly, the specific effects of the present specification are not limited to those explicitly described in the present specification, and may include various effects that can be understood or derived from the technical characteristics of the present specification.

The claims described herein may be combined in various ways. For example, the technical feature of the method claims of the present specification may be combined and implemented as an apparatus, and the technical features of the apparatus claims of the present specification may be combined and implemented as a method. In addition, the technical features of the method claim of the present specification and the technical features of the apparatus claim may be combined to be implemented as an apparatus, and the technical features of the method claim of the present specification and the technical features of the apparatus claim may be combined and implemented as a method. Other implementations are within the scope of the following claims.

1-16. (canceled)

17. A method for performing communication, the method performed by an AMF (Access and Mobility Management function) and comprising:
receiving a registration request for a network slice from a UE (User Equipment);
transmitting a response message to a base station,
wherein the response message includes i) rejection for the registration request and ii) slice information, based on the network slice being not available for the UE,
wherein the slice information includes information about frequency band and TA (Tracking Area) where the network slice is available for the UE.

18. The method of claim 17,
wherein the base station transmits cell selection information based on the slice information.

19. The method of claim 17,
wherein the slice information is transmitted to the base station, based on the UE subscribing the network slice.

20. The method of claim 18,
wherein the cell selection information includes frequency information or priority information for connecting a cell which supports the network slice.

21. The method of claim 17,
wherein the slice information includes RFSP (RAT Frequency Selection Priority) information related to the network slice.

22. A method for performing communication, the method performed by a UE (User Equipment) and comprising:
transmitting a 1st registration request for a network slice via 1st base station to a 1st AMF (Access and Mobility Management function);
receiving a response message from the 1st base station,
wherein the response message includes rejection for the request,
wherein the response message includes cell selection information which is about frequency band and TA (Tracking Area) where the network slice is available for the UE;
reselecting a cell which supports the network slice, based on the cell selection information;
transmitting a 2nd registration request message, via 2nd base station which serves the cell, to 2nd AMF.

23. The method of claim 22,
wherein the cell selection information includes frequency information or priority information for connecting the cell which supports the network slice.

24. A UE (User Equipment) configured to perform communication, the device comprising:
a transceiver,
a processor operably connectable to the transceiver,
wherein the processer is configured to control transceiver to transmits a 1st registration request for a network slice via 1st base station to a 1st AMF (Access and Mobility Management function),
wherein the processer is configured to control transceiver to receive a response message from the 1st base station,
wherein the response message includes rejection for the request,
wherein the response message includes cell selection information which is about frequency band and TA (Tracking Area) where the network slice is available for the UE,
wherein the processer reselects a cell which supports the network slice, based on the cell selection information,
wherein the processer is configured to control transceiver to transmits 2nd registration request message, via 2nd base station which serves the cell, to 2nd AMF.

25. The UE of claim 24,
wherein the cell selection information includes frequency information or priority information for connecting the cell which supports the network slice.
